(19) United States
(12) Patent Application Publication
(10) Pub. No.: US 2011/0158783 A1
(43) Pub. Date: Jun. 30, 2011

(54) LADDER SYSTEM

(75) Inventor: Neal Carlson, Maspeth, NY (US)

(73) Assignee: CONSOLIDATED EDISON COMPANY OF NEW YORK, INC., New York, NY (US)

(21) Appl. No.: 12/770,106

(22) Filed: Apr. 29, 2010

Related U.S. Application Data
(60) Provisional application No. 61/274,128, filed on Dec. 24, 2009.

(51) Int. Cl. F16M 13/02; F16M 13/00; E06C 7/00; E06C 7/06

(52) U.S. Cl. 414/800; 248/342; 182/129

(57) ABSTRACT

A ladder system is provided for facilitating access through a confined opening. The system includes a support arrangement having a first bar. The first bar may be positioned on a surface adjacent an opening. A removable ladder support cradle, including a pair of ladder supports, is coupled to the first bar. A ladder is removably coupled to the support cradle within the opening.

### BACKGROUND OF THE INVENTION

The subject matter disclosed herein relates to a ladder system for allowing a user to ascend or descend vertical distances, and in particular to a ladder system configured to gain access through a confined space, such as into an underground structure through as a manhole.

Ladders are commonly used to assist users in reaching locations that are not accessible due to their vertical location relative to the user. These locations may be vertically above the user, such in a tree or a utility pole for example. Ladders may also be used when the location is below the user, such as a hole in the ground. Ladders are commonly used by service personnel with manholes to access underground chambers that house infrastructure components, such as but not limited to electrical distribution equipment, telecommunications equipment, natural gas conduits, water conduits and sewers for example. A manhole is generally a circular hole formed in the roadway, sidewalk or ground that is sized to allow service personnel to enter and exit the underground chambers. Generally, manholes are 22 inches (559 millimeters) to 60 inches (1524 millimeters) in diameter and may weigh up to 250 pounds (113 kilograms).

While some manholes may have features such as steps or built in ladders, commonly there are no provisions for assisting the service personnel in reaching the floor of the underground chamber. In these circumstances, the service personnel will lower a ladder to facilitate the ingress and egress from the chamber. When a ladder is inserted within a manhole, the ladders are usually positioned against one side of the manhole opening and arranged on an angle prevent the ladder from slipping or moving during use. It should be appreciated that this angling of the ladder reduces the amount of available clearance space between the ladder and the sides of the manhole hindering access to the underground chamber. To provide greater access, the ladder may be arranged on a steeper angle, making the ladder more difficult to use.

Accordingly, while existing ladders are suitable for their intended purposes, there remains a need for improvement in providing a ladder that may be easily deployed for use in entering and exiting underground structures.

### BRIEF DESCRIPTION OF THE INVENTION

According to one aspect of the invention, a ladder system for entry into an opening for an underground structure is provided. The ladder system includes a first bar. A support cradle having a member is adapted to receive a first ladder rung on the ladder. The support cradle is arranged for attachment to the first bar.

According to another aspect of the invention, a method of supporting a ladder within an opening is provided. The method includes the step of arranging a first bar on a sidewalk adjacent the opening. A support cradle is coupled on the first bar. A first rung is captured on the ladder within a top portion of the support cradle.

According to yet another aspect of the invention, a ladder system is provided having a ladder having a first rung. A first bar is operably coupled to the ladder and arranged substantially perpendicular to a longitudinal length of the ladder. A second bar is rotatably coupled to a first end of the first bar, the second bar being rotatable between a first position and a second position. A first member is removably coupled between the first bar and the first rung.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a top perspective view of the manhole ladder support within a manhole opening in accordance with the invention;

FIG. 2 is a top perspective view of the manhole ladder support of FIG. 1 with a ladder attached thereto;

FIG. 3 is a top perspectives view the manhole ladder support in accordance with the invention prior to assembly of the manhole ladder support components;

FIG. 4 is a top perspective view of the manhole ladder support in accordance with the invention after assembly of the components; and,

FIG. 5 is a top perspective view of a further ladder cradle for use with the manhole ladder support in accordance with the invention.

The detailed description explains embodiments of the invention, together with advantages and features, by way of example with reference to the drawings.

### DETAILED DESCRIPTION OF THE INVENTION

Embodiments of the present invention provide a method and device for entering and exiting underground structures, such as underground utility chambers. Embodiments of the invention may be discussed in relation to an electrical utility service and equipment, but the claimed invention is not so limited. The method and device discussed herein may be used with any underground structure having an entrance that provides for a vertical entrance or exit. These underground structures may include but are not limited to electrical utility service and equipment, telecommunications utility service and equipment, water and natural gas utility service and equipment, sanitation service and equipment, and television utility service and equipment for example. In accordance with one embodiment of the invention, a simple removable assembly is provided to which the top of a ladder may be attached or supported without involving complex connectors and the like to prevent ladder slippage. In accordance with another embodiment of the invention, a simple, convenient arrangement is provided for removable attachment to a ladder assembly that is arranged within a manhole to facilitate use of the ladder by service personnel. In accordance with yet another embodiment of the invention, a simple, convenient means of egress from a manhole provided in the event fast egress or exit is desired.

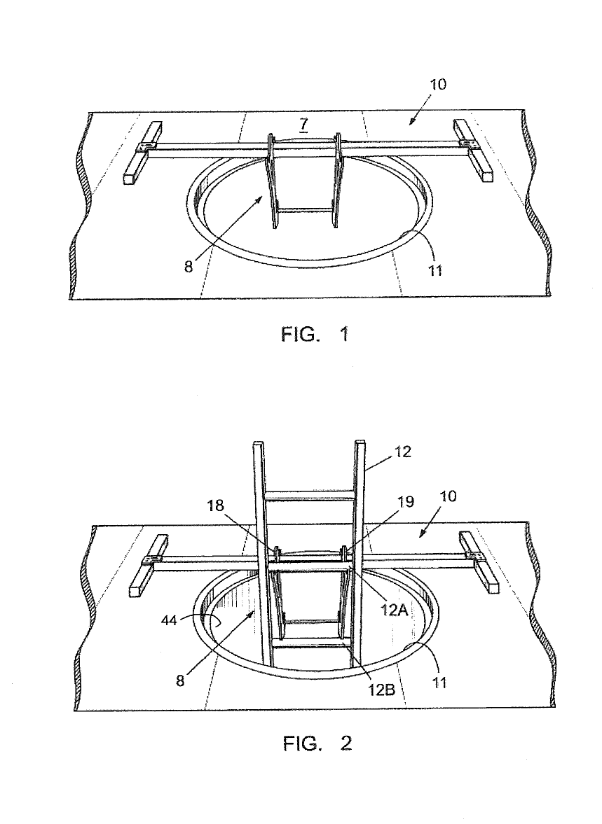

Referring now to FIGS. 1 and 2 a ladder support 10, according to one embodiment of the invention is provided. The ladder support 10 is arranged on a sidewalk 7 surrounding a manhole opening 11. A ladder cradle 8 is coupled to the ladder support 10 and is arranged for receiving a ladder 12. The ladder 12 includes a plurality of rungs that are used by the service personnel to ascend or descend the ladder 12. One of the ladder rungs 12A, which is located above ladder rung 12B, is captured within a cradle U-shaped supports 18, 19 in the manner to be described below.

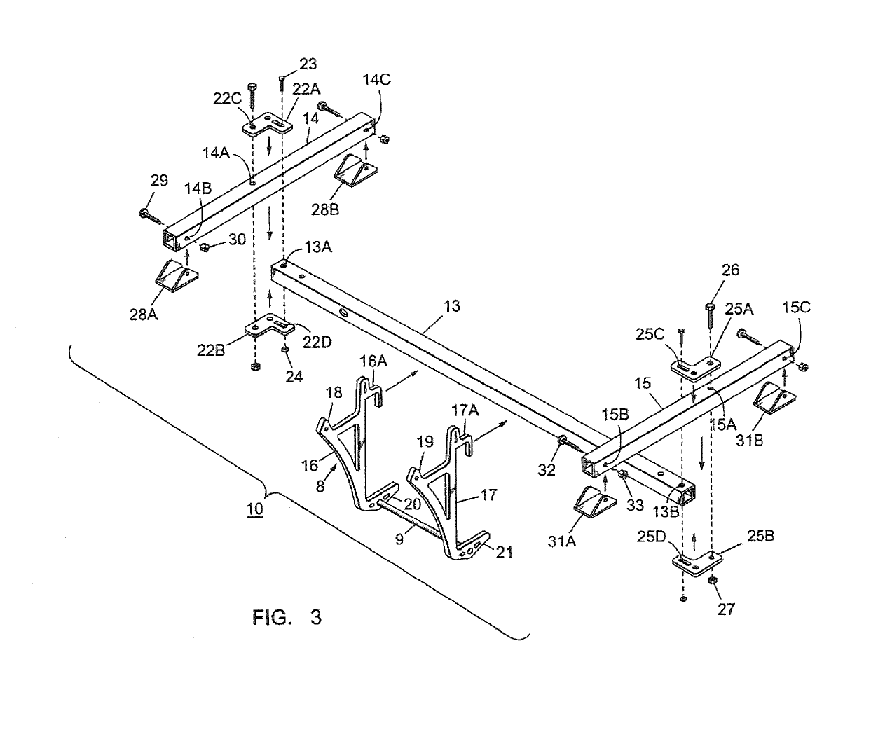

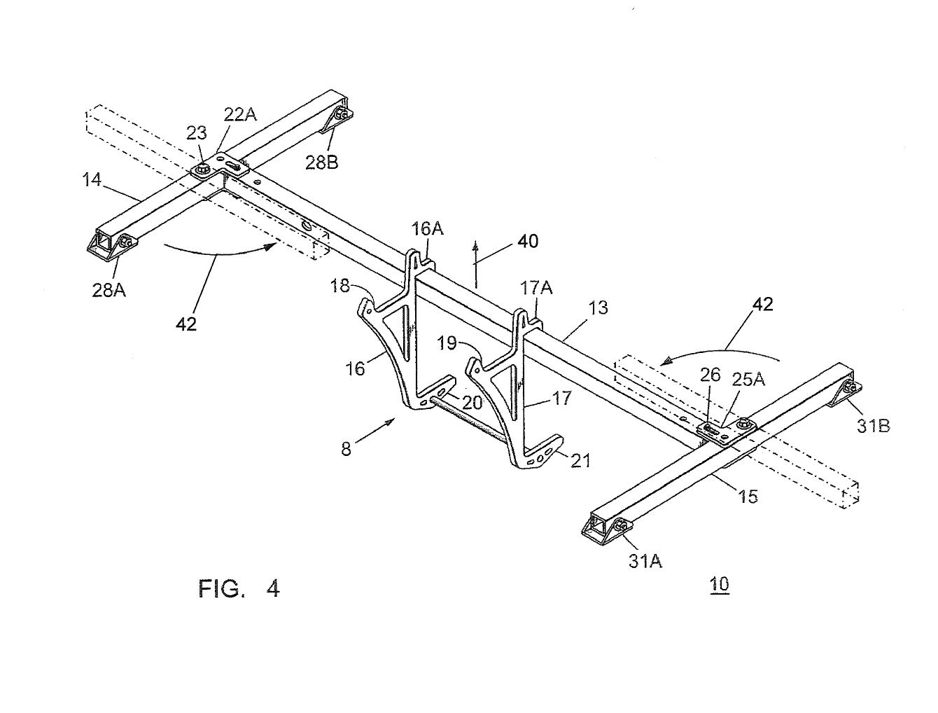

FIG. 3 illustrated an exploded view of the components of the ladder support 10. The ladder support 10 includes an elongated center bar 13, a first side bar 14 and an opposing side bar 15 at the opposite end thereof. In the exemplary embodiment, the side bars 14, 15 are substantially perpendicular to the center bar 13. In one embodiment, the bars 13, 14, 15 have a rectangular cross-section and are fabricated from a metal, such as aluminum for example.

The ladder cradle 8 includes a pair of supports 16, 17 joined at the bottom via a rod 9 which is coupled at to the supports 16, 17 at each end thereof. In the exemplary embodiment, the coupled to the supports 16, 17 by welding and have a rectangular cross-section. The supports 16, 17 include U-shaped supports 18, 19 at the top thereof for receiving the ladder 12 (FIG. 2) and L-shaped extensions 20, 21 that contact a surface or wall 44 on the inside of the manhole opening 11. The hooks 16A, 17A, extend from the U-shaped supports 18, 19 and are positioned over the center bar 13 as illustrated in FIG. 1.

A pair of angular plates 22A, 22B, are positioned on opposite sides of the center bar 13 and side bar 14 and are attached to the center bar 13 and side bar 14 via openings 22C, 22D in the plates 22A, 22B and openings 13A, 14A in the elongate bar and the side bar by means of fasteners 23, 24. In one embodiment, the center bar 13 and side bar 14 are coupled by welding.

A pair of angular plates 25A, 25B, are positioned on opposite sides of the center bar 13 and side bar 15 and are attached to the center bar 13 and side bar 15 via openings 25C, 25D in the angular plates 25A, 25B and openings 13B, 15A in the center bar and the side bar by means of fasteners 26, 24. In one embodiment, the center bar 13 and the side bar 15 are coupled by welding.

Anti-skid plates 28A, 28B are attached at opposite ends of the side bar 14. In the exemplary embodiment, the plates 28A, 28B are coupled via fasteners 29, 30 via openings 14B, 14C. Anti-skid plates 31A, 31B are attached at opposite ends of the side bar 15. In the exemplary embodiment, the plates 31A, 31B are attached via fasteners 32, 33 through openings 15B, 15C. In one embodiment, the plates 28A, 28B and 31A, 31B are fabricated from a solid rubber compound to provide a desired anti-slip/anti-skid property.

One embodiment of an assembled ladder support 10 is illustrated in FIG. 4. In this embodiment, the center bar 13 has the side bars 14, 15 attached via plates 22A, 25A and with the anti-skid plates 28A, 28B and 31A, 31B attached to the ends thereof. The ladder cradle 8 is positioned on the center bar 13 by arranging hooks 16A, 17A on the tops of the supports 16, 17 over center bar 13.

When the ladder support 10 is positioned relative to a manhole 8 (FIG. 1), and the ladder 12 is positioned on the ladder support 10 by coupling one of the ladder rungs 12A within the U-shaped supports 18,19 (FIG. 2), the L-shaped extensions 20, 21 on the supports 16, 17 will abut against the manhole sidewalls (not shown). It should be appreciated that this arrangement provides advantages in maintaining a desired clearance between the ladder 12 and the manhole sidewalls.

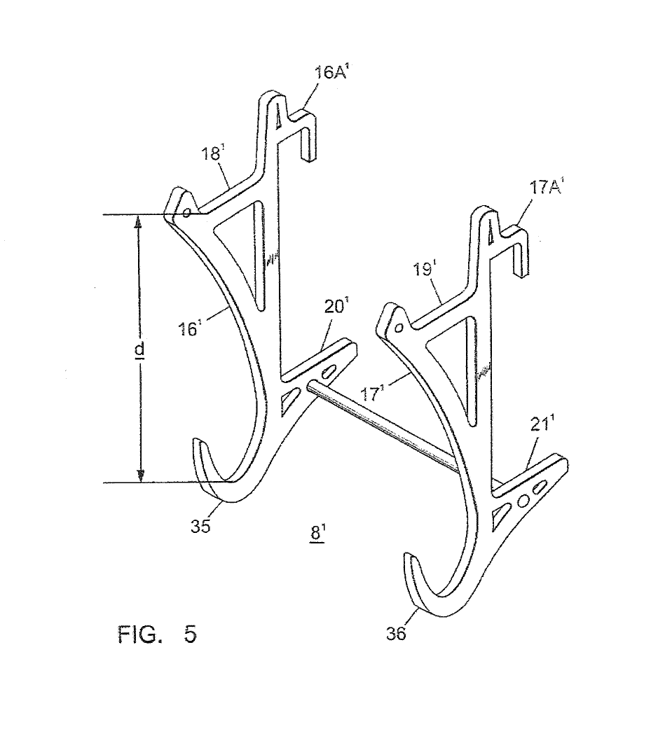

Referring now to FIG. 5, another embodiment of a ladder cradle 8′ is illustrated. The ladder cradle 8′ includes first and second supports 16′, 17′ with hooks 16A′, 17A′ arranged opposite thereto. An L-shaped extensions 20′, 21′ extend from one side of the ladder cradle 8′ and J-shaped extensions 35, 36 are subjacent the U-shaped supports 18′, 19′. A pair of J-shaped extensions 35, 36 are arranged on the supports 16′, 17′ subjacent the U-shaped supports 18′, 19′.

The spacing distance “d” between the U-shaped supports 18′, 19′ and J-shaped extensions 35, 36 is adapted to be substantially the same distance as between two successive ladder rungs 12A, 12B, on the ladder 12 (FIG. 2). With this configuration, the ladder rung 12A, may be captured within the U-shaped supports 18′, 19′ and the ladder rung 12B may be captured within the J-shaped extensions 35, 36 when the ladder cradle 8′ is used in place of the ladder cradle 8 described earlier. The provision of the J-shaped extensions 35, 36 in combination with the U-shaped supports 18′, 19′ inhibits the ladder 12 from swinging away from the manhole opening 11 (FIG. 2) during operation.

When the service personnel complete the desired tasks within the manhole opening 11, the ladder 12 may be removed from the ladder cradle 8 by lifting the ladder rung 12A out from the U-shaped supports 18, 19. With the ladder 12 decoupled, the ladder cradle 8 may be removed from center bar 13 by moving the cradle in the direction of arrow 40 as shown in FIG. 4. To facilitate storage and transportation of the center bar 13, the fasteners 23, 26 on the angular plates 22A, 25A are loosened and the side bars 14, 15 are rotated in the counterclockwise in the direction indicated by arrow 42 to form a linear arrangement where the side bars 14, 15 are substantially parallel to the center bar. The rotated (linear) position is illustrated in FIG. 4 in phantom. It should be appreciated that while the embodiments illustrated herein show the side bars 14, 15 as being arranged substantially perpendicular when in the deployed position, the side bars 14, 15 may also be arranged on an angle relative to the center bar 13 to accommodate obstructions or other surface irregularities.

A ladder support arrangement is provided whereby a ladder can be inserted within a manhole with part of the support extending from the manhole to the adjoining sidewalk or other adjacent surface. The ladder is held in contact with the support by capturing a ladder rung within a pair of U-shaped supports formed in the top of the support. Embodiments of the invention provide advantages in increasing the amount of space available for service personnel to enter and exit the entrance to an underground structure. Embodiments of the invention further provide advantages in increasing the stability of the ladder during use to facilitate the entry and exit of service personnel from underground chambers. Embodiments of the invention provide yet further advantages in being easily configured for transportation and deployment.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A ladder system for entry into an opening of an underground structure, said ladder system comprising:
a first bar; and,
a support cradle having a member adapted to receive a first ladder rung on said ladder, said support cradle arranged for attachment to said first bar.

2. The ladder system of claim 1 further comprising a pair of second bars each coupled to an end of said first bar.

3. The ladder system of claim 1 wherein said support cradle includes a first rectangular hook extending from said support cradle for attachment to said first bar.

4. The ladder system of claim 3 wherein said member further comprises a first U-shaped support adjacent said first rectangular hook.

5. The ladder system of claim 1 further comprising a first L-shaped member formed on a first portion of said support cradle for contacting a surface defined within said opening.

6. The ladder system of claim 5 including a first J-shaped member formed on said first portion of said support cradle, opposite said first L-shaped member, said first J-shaped member adapted for receiving a second rung on said ladder.

7. The ladder system of claim 2 including a plate coupled to each end of said pair of second bars.

8. The ladder system of claim 3 further comprising a second rectangular hook adjacent said first rectangular hook for further attachment to said first bar.

9. The ladder system of claim 6 including a second L-shaped member connected with said first L-shaped member for contacting said surface defined within said opening.

10. The ladder system of claim 4 including a second U-shaped support adjacent said first U-shaped support for receiving said first ladder rung.

11. The ladder system of claim 9 including a second J-shaped member formed on said first, opposite said second L-shaped member, said second J-shaped member being adapted to receive said second rung on said ladder.

12. The ladder system of claim 9 including a rod extending between said first L-shaped member and said second L-shaped member.

13. A method of supporting a ladder within an opening comprising the steps of:
arranging a first bar on a sidewalk adjacent said opening;
coupling a support cradle on said first bar; and,
capturing a first rung on said ladder within a top portion of said support cradle.

14. The method of claim 13 further comprising the step of capturing a second rung on said ladder within a portion of said support cradle.

15. The method of claim 14 further comprising the step of rotating a second bar about said first bar from a first position to a second position.

16. The method of claim 15 wherein said second bar is substantially parallel to said first bar in said first position.

17. The method of claim 16 wherein said second position is substantially perpendicular to said first position.

18. A ladder system comprising:
a ladder having a first rung;
a first bar operably coupled to said ladder and arranged substantially perpendicular to a longitudinal length of said ladder;
a second bar rotatably coupled to a first end of said first bar, said second bar being rotatable between a first position and a second position; and,
a first member removably coupled between said first bar and said first rung.

19. The ladder system of claim 18 further comprising a second member removably coupled between said first bar and said first rung.

20. The ladder system of claim 19 wherein said first member and said second member each comprise:
a rectangular hook portion extending coupled to said first bar;
a U-shaped support adjacent said rectangular hook portion; and,
an L-shaped portion arranged opposite said rectangular hook portion.
